(19) United States
(12) Patent Application Publication
(10) Pub. No.: US 2024/0092636 A1
(43) Pub. Date: Mar. 21, 2024

(54) A Method For Improving Fuel Pyrolysis In A Wave Reformer Using Channel Area Contraction

(71) Applicant: New Wave Hydrogen, Inc., Calgary (CA)

(72) Inventors: Pejman Akbari, Pasadena, CA (US); Colin D. Copeland, Pitt Meadows (CA); Stefan Tuechler, Bath (GB); Ghislain Maxime Romuald Madiot, West Vancouver (CA)

(73) Assignee: New Wave Hydrogen, Inc., Calgary (CA)

(21) Appl. No.: 18/370,208

(22) Filed: Sep. 19, 2023

Related U.S. Application Data
(60) Provisional application No. 63/408,354, filed on Sep. 20, 2022.

(51) Int. Cl. C01B 3/24

(52) U.S. Cl. CPC C01B 3/24; C01B 2203/0211; C01B 2203/0805

(57) ABSTRACT

This invention is for a hydrogen generation system using a wave reformer in which shock and expansion waves are created in a manner causing head-on colliding shock waves and multi-stage compression where reacting gases within the wave reformer are heated and compressed to thermally crack or decompose one or more fuel sources, such as hydrocarbon fuels, to generate a fuel product containing hydrogen, where the internal configuration of channels within the wave reformer are defined by a shaped portion along a length thereof.

### BACKGROUND OF THE INVENTION

### Field of the Invention

The present invention relates generally to hydrogen generation systems that include a wave reformer to thermally crack or decompose fuel sources, such as hydrocarbon fuels, to produce a fuel product containing hydrogen, and to methods of operating such systems.

### Description of Related Art

Fossil fuels have drastically been affecting the environment for many years, and are considered as being prime contributions to global warming. Hydrogen, as a carbon-free energy carrier, will play a critical role in reducing or even eliminating greenhouse gas emissions. Additionally, hydrogen shows a broad range of existing and potential applications including, but not limited to, the electricity, transport, propulsion, and heating industries.

### I. Introduction

Hydrogen has been identified as a promising energy carrier for the transportation and energy sectors that can reduces greenhouse gas emissions. Conventional H₂ production processes (e.g. steam methane reforming-SMR) have the drawback of producing large amounts of CO₂ to atmosphere. H₂ production from electrolysis, even using renewable energy, still also consumes freshwater resources and has a high electricity demand. To slow global warming and mitigate harmful environmental effects of greenhouse gases, it is critical to develop and commercialize new methos for H₂ production with low CO₂ emissions as soon as possible. New Wave Hydrogen, Inc. (NWH₂) has recently explored a method for methane cracking via shock wave heating. The NWH₂ process is a novel application of a known technology (wave rotors) and proven process (shock wave driven methane pyrolysis). In such a wave rotor-based fuel reformer, the energy (pressure) embodied in a pressurized natural gas pipeline (e.g. methane) is used to initiate shock waves in the reformer used for heating a hydrocarbon fuel and decomposing it by rapid shock compression. The innovation is efficient, uses no water, generates no direct CO₂, uses existing infrastructure with little change, and has the potential of significantly reducing the present cost of H₂ production. These attractive features of the shock wave reformer can substitute this technology with the more common catalytic or SMR techniques. This solution can create a fundamental paradigm shift in the power generation industry. It can offer a solution to a near-term national need as well as a long-term world energy crisis. NWH₂ wave reformer has undergone detailed design in collaboration with number of industrial partners and research institutes and a series of experiments are being conducted to demonstrate its efficient operation.

### BRIEF DESCRIPTION OF FIGURES

The invention is better understood by reading the following detailed description with reference to the accompanying drawings in which:

FIG. 1 is a schematic drawing of a four-port wave rotor;

FIG. 2 is a wave diagram of a four-port reverse-flow wave reformer;

FIGS. 3a-3c show shock wave propagation in a straight channel (3a) and in channels (33b) and (c) where they are gradually constricted in the direction of propagation;

FIGS. 4a and 4b show the contours of non-dimensional pressure (left), and temperature in a four-port reverse-flow wave reformer with straight channels;

FIGS. 5a and 5b show the contours of non-dimensional pressure (5a), and (5b) temperature in a four-port reverse-flow wave reformer with convergent channels;

FIGS. 6a and 6b show the contours of non-dimensional pressure (6a), and temperature (6b) in a four-port reverse-flow wave reformer with convergent channels;

FIG. 7 shows a wave diagram of a six-port reverse-flow wave reformer;

FIG. 8a-8f: Contours of non-dimensional pressure, temperature, and Mach number (top) and molar fraction of CO₂, CH₄, and H₂ (bottom) in a six-port wave reformer with straight channels;

FIG. 9 shows a channel with linearly decreasing cross-sectional area in the direction of travel of head-on colliding shock waves;

FIG. 10a-10i shows the contours of non-dimensional pressure, temperature, and Mach in a six-port wave reformer with channels that vary in cross sectional area;

FIG. 11a-11i show the molar fraction of CO₂, CH₄, and H₂ in a six-port wave reformer with channels that vary in cross sectional area;

FIG. 12: Wave diagram of an eight-port reverse-flow wave reformer.

FIGS. 13a-13f represent a numerical modeling of an eight-port wave reformer with straight channels incorporating the wave cycle details and the contours of non-dimensional pressure, temperature, and Mach number (top) and molar fraction of CO₂, CH₄, and H₂ (bottom) in an eight-port wave reformer with straight channels;

FIG. 14a-14i show the contours of non-dimensional pressure, temperature, and Mach in an eight-port wave reformer with channels that vary in cross sectional area; and

FIG. 15a-15i shows the molar fraction of CO₂, CH₄, and H₂ in an eight-port wave reformer with channels that vary in cross sectional area.

### DETAILED DESCRIPTION OF THE INVENTION

### II. Wave Reformer Description

The wave reformer is a wave rotor in which a gaseous fuel (reacting gas) is heated by a driver gas to extremely high temperatures very rapidly in order to crack the fuel entering the reformer. Identical to conventional wave rotors, the wave reformer consists of a series of long, narrow channels arranged side-by-side on the periphery of a spinning drum. These channels are progressively charged and discharged by rapidly spinning the drum past a few ports or manifolds placed on two stationary endplates. Rapid exposure of the channels to these end ports initiates compression and expansion waves within the channels, the equivalent of sudden rupturing a diaphragm in a shock tube. Therefore, unlike a steady-flow turbomachine component, which either compresses or expands the fluid, both compression and expansion are accomplished within a single component. The flows in the inlets/exits of a wave reformer are essentially steady, similar to conventional turbomachinery. However, the processes within the wave reformer are unsteady.

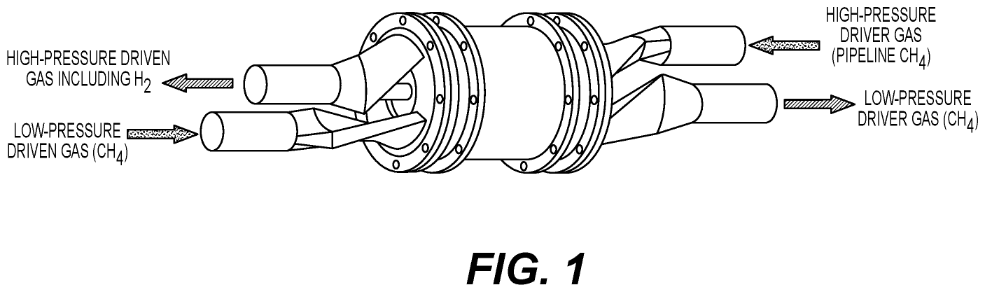

A schematic of a four-port wave reformer is shown in FIG. 1. The wave reformer shown here is identical to conventional four-port pressure-exchange wave rotors where a high-pressure driver gas exchanges its energy with a low-pressure driven (reacting) gas within the spinning channels. The entry and exit ports function as rotating valves, resembling the diaphragm in a conventional form of shock tube. At least one shock wave is generated in the channels when the channels are exposed to a high-pressure driver gas port which enters the channels and compresses the gas within it. This transfers the driver gas energy to the driven gas. Leveraging the energy entrained in a pressurized delivery line, NWH₂ wave reformer is envisioned to use high-pressure natural gas pipeline as the driver gas to crack a low-pressure methane gas as the reacting gas. The former provides the energy into the system and the latter absorbs that energy to achieve the necessary reaction.

From the early 1950's to today, wave rotors have also been used as a chemical reactor and pyrolizer. Hertzberg and his colleagues at Cornell Aeronautical Laboratory (CAL) used a wave rotor to heat a gas to high reaction temperatures to promote the formation of useful products. Particular attention was given to the production of nitrogen oxide from air as well as the conversion of Butane to Acetylene. Using a chemical wave reactor, gas temperatures beyond 2500° K was generated that was required for the thermal fixation of nitrogen directly from air and producing significant concentrations of NO. Such studies formed the foundation of the successfully development and operation of the CAL Wave Superheater for over a decade in the late 1950's and 1960's. The Wave Superheater was designed to continuously compress and heat air to temperatures greater than 3500 K and up to 120 atm. Subsequent work led to refinements in the ability to simulate continuous production and a range of novel designs and wave cycles. Hertzberg and colleagues were pioneers in this, exploring composite wave cycles designed to prolong residence times and various designs intended to increase peak temperatures.

### Inner Working Principles of a Four-Port Reverse-Flow Wave Reformer

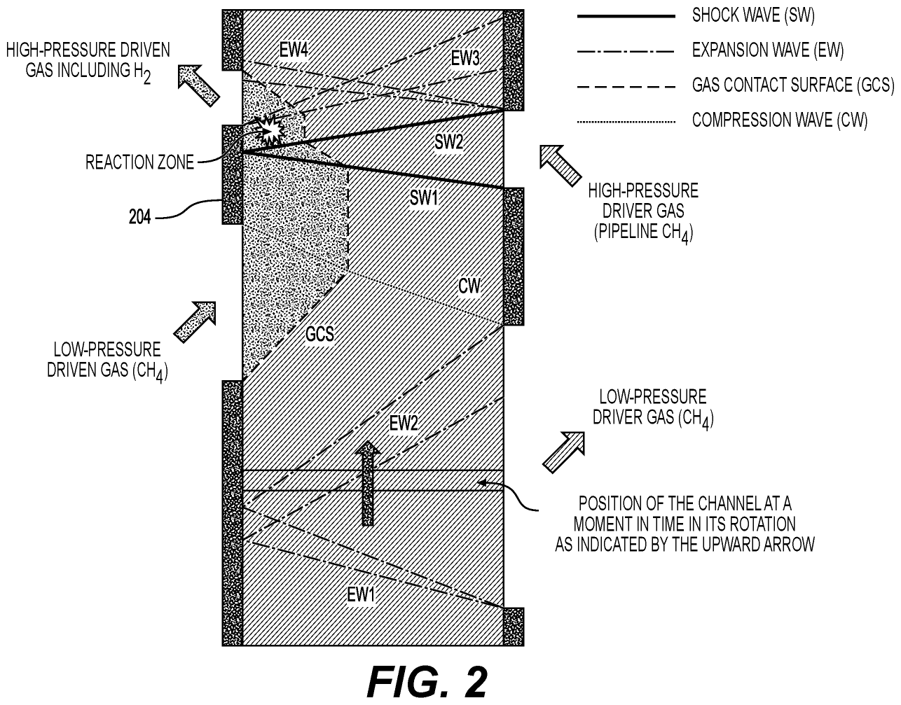

To better understand how a wave reformer operates, it is useful to describe the inner working principles and the unsteady flow process within wave reformers in a so-called wave diagram. A wave diagram is viewed as an x-t (distance-time) which is a time-history of the flow in any single wave reformer passage as it moves through the wave reformer cycle. The top of each wave diagram is looped around and joined to the bottom of the diagram, i.e. each wave cycle is repetitive. Since the rotor channels are identical, the operation can best be understood by explaining what happens in one of the rotor channels during one complete revolution of the drum. In fact, wave diagrams can be viewed as an instantaneous snapshot of the flow in the entire rotor with the circular motion of the rotor channels is represented by straight translatory motion. FIG. 2 schematically illustrates an unwrapped demonstration of a four-port reverse-flow wave reformer with the rotor channel moving upward or vertically in the figure. The reacting gas (driven gas) and processed fuel enter and leave from the left endplate. Likewise, the high-pressure and low-pressure driver gases enter and leave from the right endplate. The vertical solid lines on each side of the channels represent the stationary end walls that establish the portion of the cycle over which the inlet and outlet ports are closed. The diagonal lines are the propagation lines (trajectories) of the waves and contact surfaces (boundaries between the fluids). Wave interactions at interfaces are ignored. The blue color represents the low-pressure driven gas and the red color represents the driver gas.

Each cycle consists of two inflow ports, where ingress of the fresh high pressure driver gas and low-pressure driven gas or fluids are fed into the moving channels, and two outflow ports, where the energized high-pressure driven gas and de-energized low-pressure driver gas are discharged from the rotor channels. For fuel reforming application, a pre-heated hydrocarbon fuel (e.g. methane) will be chosen as the reacting gas, and pre-heated pressurized natural gas supply will be selected as the driver gas. The pressure ratio between the reactant gas and driver gas is a factor determining the strength of the shock wave generated. The required pressure ratio will depend upon the reaction temperature desired to be produced for the processing of a particular reactant gas. The process can be made more efficient by either pre-heating the driver gas or pre-heating the driver gas, reducing the pressure ratio required for the process. By pre-heating these gases, the increment of temperature rise in the reactant gas that must be produced by action of the shock wave to reach the elevated temperature at which the particular chemical reaction is intended to take place will be smaller.

In FIG. 2, the cycle begins at the bottom part of the wave diagram where the flow within the channel consists of the driver gas from a previous cycle. As the right end of the channel opens to the relatively low-pressure outlet port, an expansion fan EW1 originates from the leading edge of the outlet port and propagates into the channel, expanding and discharging the used driver gas to the surrounding. The expansion fan EW1 reflects off the left wall as EW2 and further reduces the pressure and temperature in the channel. This draws fresh low-pressure driven gas, the reacting gas into the channel when the inlet port starts to open on the left side of the channel. This entering reacting (driven) gas is separated from the driver gas by a contact surface shown at GCS. When the reflected expansion fan EW2 reaches the upper edge of exhaust port, it slows the outflow. By closing the driver gas outlet port, a compression wave CW (aka hammer shock) is generated from the trailing edge of the outlet port. The compression wave CW travels toward the inlet port stopping the channel flow. As the compression wave CW reaches the upper corner of the inlet port, that port closes gradually. At this moment, the channel is closed at both ends filled with the reacting gas separated from the driver gas by a contact surface GCS denoted by a vertical line, and the channel fluid is at rest relative to the rotor. Through continuous rotation of the rotor, the fresh driver gas entry port opens, and the channel right end is exposed to the fresh high-pressure driver gas. Because the driver gas pressure is higher than the gas pressure in the channel, a shock wave SW1 is triggered starting from the lower corner of the high-pressure inlet port. The shock wave SW1 runs to the left through the channel and causes an abrupt rise of pressure and temperature inside the channel Behind the shock wave SW1, the compressed fresh driven gas, and the driver gas are separated through the gas interfaces along CGS. As the shock wave SW1 reaches the end of the channel, a reflected shock wave SW2 is generated, propagating to the right back into the channel which compresses the channel fluid further. Passage of the shock waves SW1 and SW2 through the reactant gas raises it to reaction temperature, thus thermal decomposition of the fuel occurs behind the reflected wave in a hot reaction zone. When the processed gas exhaust port opens, the doubled-compressed reacting product (e.g. hydrogen and any intermediaries) is expelled from the channel by an expansion fan EW3 generated at the lower corner of the exhaust port propagating downstream toward the inlet endplate. The closure of the inlet port is timed with the arrival of the reflected shock wave SW2. At this moment, another expansion fan EW4 originates from the upper corner of the inlet port and propagates to the left toward the other end of the channel which eventually brings the channel flow to rest. When the expansion fan EW4 reaches the end of the channel, the processed exhaust port closes and the flow in the rotor channels stops and contains the driver gas. At this point, the channel will go through the same cycle process. The described sequence of events occurs successively in each of the reactor channels as the drum is rotated so that a continuous supply of processed gas is discharged into the processed gas exhaust port.

### III. Shock Wave Strengthening Through Area Reduction

Shock waves are essentially waves propagating at supersonic speeds. They are very thin and immediately raise the temperature and pressure in the gas they travel through. Therefore, the stronger the shock, the higher the increase in pressure and temperature through the gas it propagates. One of the major challenges in the fuel pyrolysis application of wave reformers is the generation of the required strong shock waves. The common practice is to increase the strength of the shock waves by increasing the pressure ratio between the driven and driven gases as well as preheating the driver gas temperature for a given channel configuration. By altering the wall shape and reducing the cross-sectional area of the channel, i.e. channel contraction, the shock wave could be significantly strengthened. When a moving shock wave reaches the convergent (or divergent) part of a channel, its intensity changes in response to the channel area variation. It has been confirmed that when a plane normal shock wave travels down a channel where a decrease in cross-sectional area exists, i.e. a convergent channel, the shock wave is expected to strengthen and the average speed of the shock wave increases. Consequently, the gas temperature behind the shock wave rises which is favorable in fuel pyrolysis in a wave reformer. Hence, it is proposed to design a wave reformer with convergent channels to achieve higher temperature required for fuel cracking.

### A Four-Port Reverse-Flow Wave Reformer Using Channel Area Contraction

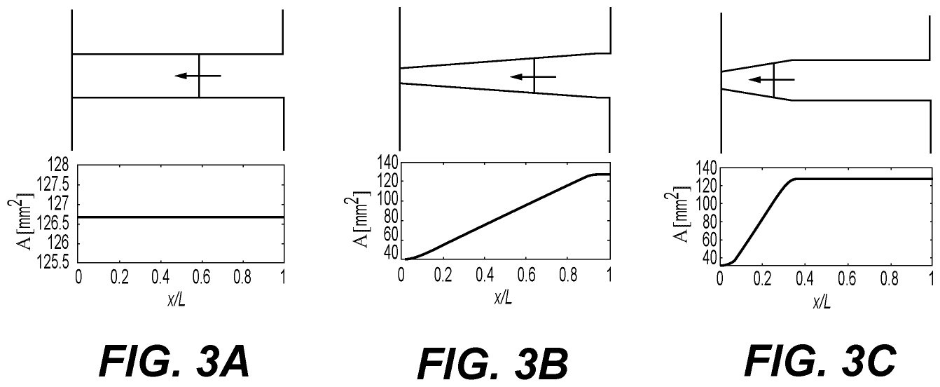

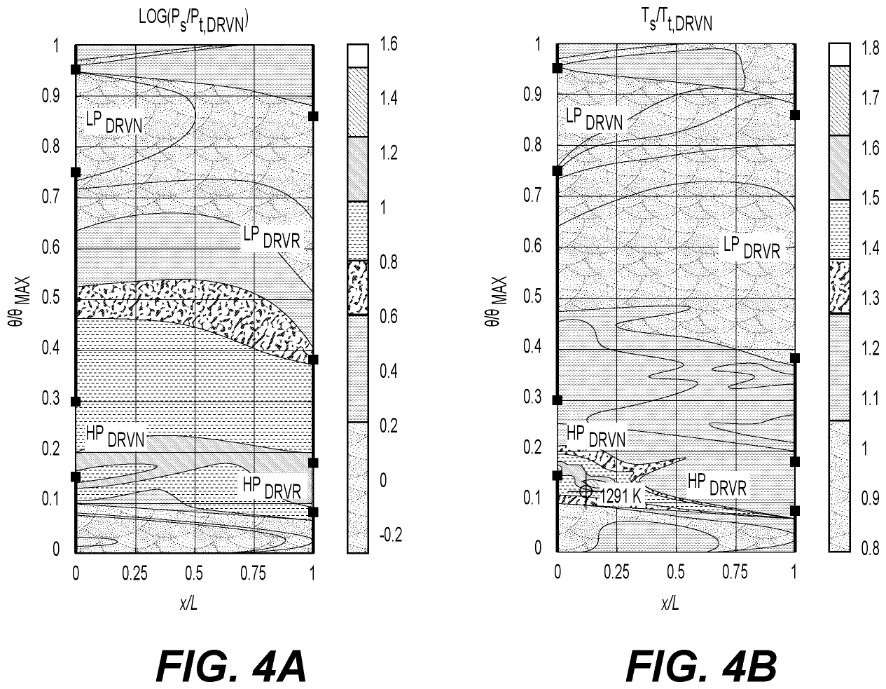

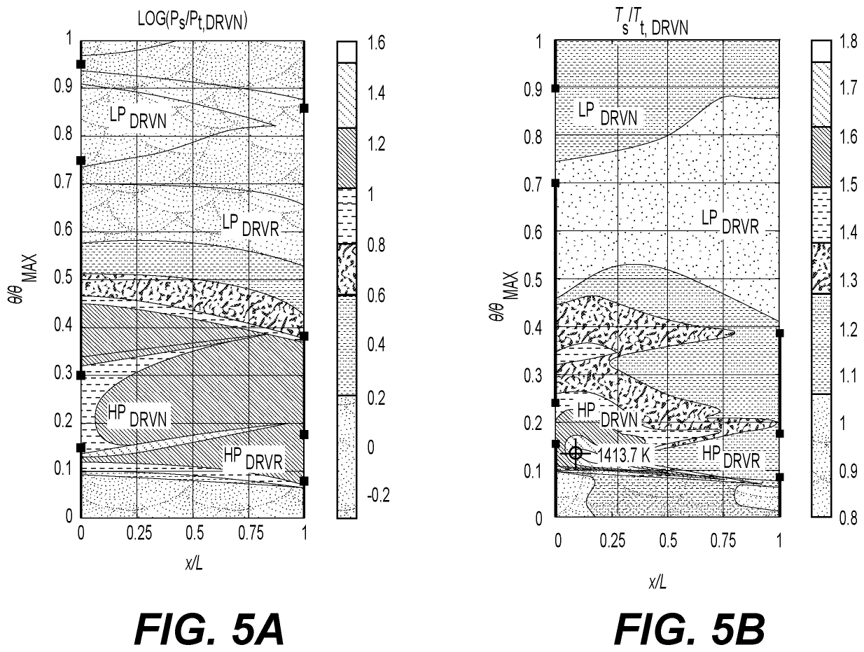

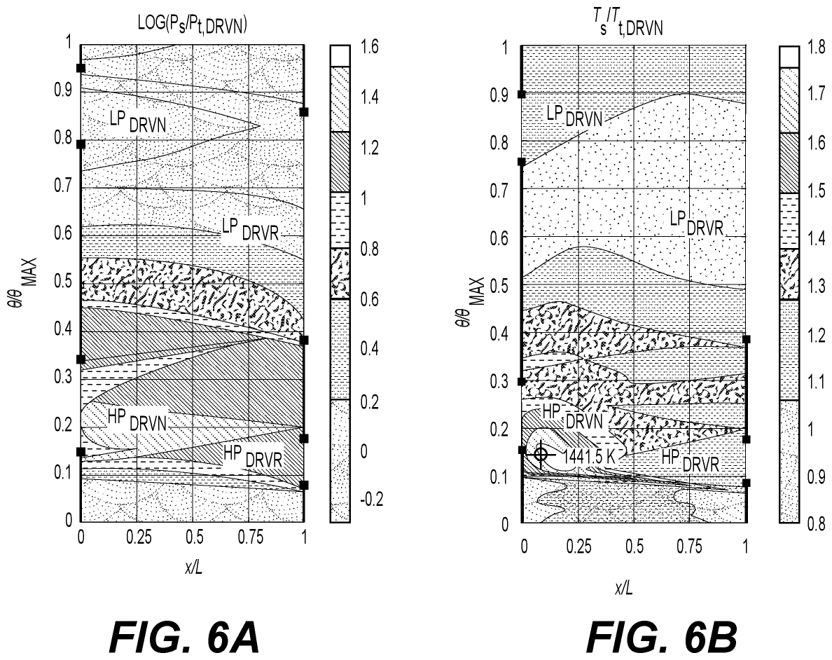

FIGS. 3a-3c shows a channel of a wave reformer with three different channel profiles. In the first configuration 3(a), the wave reformer has straight channels where in the second 3(b) and third 3(c) configurations the channels differently vary in cross sectional area to provide gradually decreasing area in the direction of travel of the shock waves. FIGS. 4-6 represent local (static) pressure and temperature contours of four-port reverse-flow wave reformers using the channel profiles introduced in FIG. 3. The terms “HP” and “LP” refer high pressure and low pressure, respectively. Also, in FIGS. 4-6 the terms “DRVR” and “DRVN” refer to driver and driven gasses, respectively. The numerical results are consistent with flow patterns schematically illustrated in FIG. 2. Hence, axial distance is non-dimensionalized by channel length, L. Vertical axis represented by angular displacement is non-dimensionalized by maximum angular displacement, □ₘₐₓ, which is 360 degrees. The pressure and temperature are non-dimensionalized by the gas stagnation state properties of incoming driven gas at the inlet port.

It can be seen that while the wave patterns are similar, but the peak temperature(s) in the post-shock region indicated by its absolute value is not the same for all cases. For instance, the channel profile corresponds to Case (c) in FIG. 3c shows the greatest value (1441.5 K) among all three cases. Also, both convergent channels have higher peak temperatures, 1413.7 K and 1441.5 K, respectively, compared with the straight channel with a peak temperature of 1291 K. This is consistent with the flow behavior when a shock wave propagates inside a convergent section of a channel, as discussed above.

### A Six-Port Reverse-Flow Wave Reformer Using Channel Area Contraction

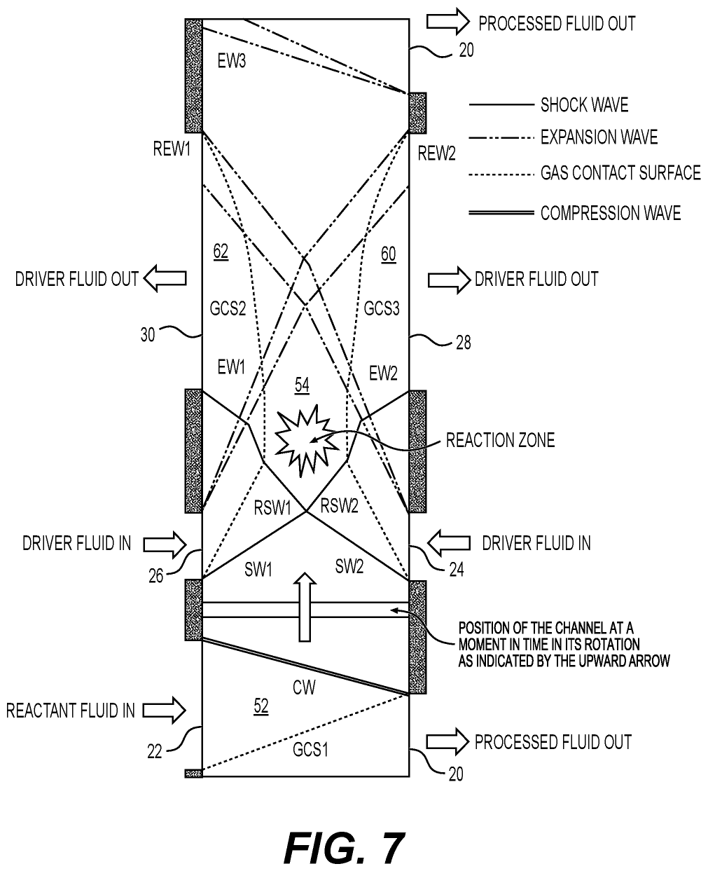

The idea of using channel with contraction can be implemented in other wave reformer designs in which a greater number of ports are used. For instance, a six-port wave reformer is considered here. The inner working fluid principles are shown in a wave diagram in FIG. 7. In this proposed cycle, the reaction zone is designed to be placed in an intermediate or middle section of the channel, thereby the region of high temperature and pressure occurs in the central portion of the process gas column and not at an end which must be sealed against a reflecting plate. This can be done by simultaneously introduction of opposing pairs of shock waves at opposite ends of the channels. Because reflecting a shock wave from a plane wall is analogous to the head-on collision of two shock waves of equal strength, thus, wave diagram shown in FIG. 7 is expected to provide a similar heating process for the reactant gas comparable with that in the cycle described in FIG. 2 without end wall-effects.

In FIG. 7, the present process begins at the bottom of the wave diagram where the low-pressure reactant fluid or gas entry port 22 opens at left side of diagram. The fresh reactant fluid 52 is charged into the upstream end of the channel (left side of diagram) while the processed fluid (e.g. product) is being discharged from the downstream end of the channel (right side of diagram) through an exhaust port 20. This is considered as the overlap process in which both channel ends at the bottom of the figure are open. A gas contact surface (GCS1) separates the fresh reacting gas 52 from the exhaust gas. When the entire channel is filled with the fresh reacting gas, the exit port 20 closes. By closing the outflow port 20, a compression wave CW (doubled solid line) is generated from the upper corner of the exit port 20 propagating to the left. The channel flow is brought to rest by this moving wave CW (a.k.a. hammer shock), which raises the pressure in the channel. When the compression wave CW meets the upper corner of the inlet port 22, the ingestion of the fresh gas into the channel is stopped. At this instance, the channel is fully filled with the pre-compressed fresh reacting gas. As the channel rotates further, the channel ends are exposed to high-pressure driver gas entry ports 24 and 26. Because the driver gas pressure is higher than the pressure in the channel, two identical primary shock waves SW1 and SW2, are triggered starting from the lower corners of the inlet ports 24 and 26. These primary shock waves SW1 and SW2 propagate toward each other and after colliding cause a sudden rise of pressure and temperature inside the channel in a reaction zone. Meanwhile, the driver gas entry ports 24 and 26 start to close. Because the velocity of the gas in contact with the closed end wall must be zero, expansion waves EW1 and EW2 are generated and propagated into the channel moving gas, bringing it to rest. Expansion waves EW1 and EW2 (dashed-dotted line) are generated from the upper corners of the entry ports 24 and 26 propagating toward the center of the channel reducing the pressure and temperature of the channel gas. Behind the primary shock waves SW1 and SW2, the compressed reacting gas and the driver gases 60 and 62 are separated through two contact surfaces GCS2 and GCS3 as the compression process is carried out. These contact surfaces (showing the progression of the two fluids) follow the shock waves SW1 and SW2 at a slower rate. The symmetric pairs of primary shock waves SW1 and SW2 collide in the middle of the channel and generate a pair of reflected shock waves RSW1 and RSW2. The pressure and temperature of the reacting gas in the reflection zone behind the reflected shock waves RSW1 and RSW2 rise further and the double-compressed gas 54 is brought to rest as is indicated by contact surfaces GCS2 and GCS3 turning into vertical lines. If a reacting gas like methane is selected as the driven gas, with sufficient compression by the primary and reflected shock waves, thermal dissociation of the gas to hydrogen occurs in the heated zone behind the reflected waves. Heating and compression of the gas in the middle of the channel avoids sealing challenge associated with channel end compression. The reflected waves RSW1 and RSW2 resulting from the colliding opposing shocks propagate back toward the downstream ends of the channel and pass through the opposing expansion waves EW1 and EW2.

Discharging of the channel gas to the surrounding starts by opening the driver exhaust gas ports 28 and 30 that is timed with the arrival of the reflected shock waves RSW1 and RSW2 to the leading corners of the exit ports 28 and 30. By opening the ports 28 and 30, the driver gases 60 and 62 leave the channel from both ends at a lower pressure than when they entered the rotor. The driver gases are separated by contact surfaces GCS2 and GCS3 from the compressed reacting (driven) fluid. The scavenging of the driver gases through the exit ports 28 and 30 is stopped by closing the exhaust ports 28 and 30. Similar to the primary shock waves SW1 and SW2, the expansion waves EW1 and EW2 also collide in the middle of the channel and reflected as REW1 and REW2, respectively. The closing of the exhaust ports 28 and 30 is timed with the arrival of the processed gas to the ends of the channel as well as with the arrival of the reflected expansion waves REW1 and REW2 to the upper corners of the exit ports 28 and 30. At this moment, the channel is entirely filled with the processed-driven fluid. Finally, decomposed gas (e.g. hydrogen and any intermediaries) is expelled from the channel by another expansion wave EW3 generated from the leading corner of this exhaust port 20. The discharged gas from the channels is at a pressure higher than that which it had upon entering the rotor prior to compression of the reactant. Opening of the driven gas port 22 is timed with the arrival of the expansion wave EW3 to the left end of the channel to allow fresh reacting gas enters the channel and the cycle repeats itself.

### An Eight-Port Reverse-Flow Wave Reformer Using Straight Channel

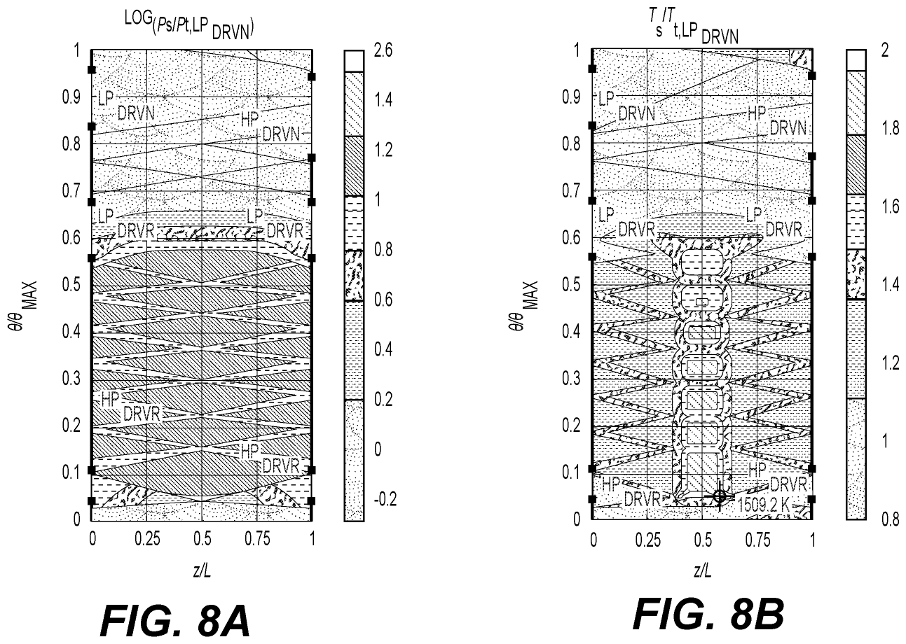

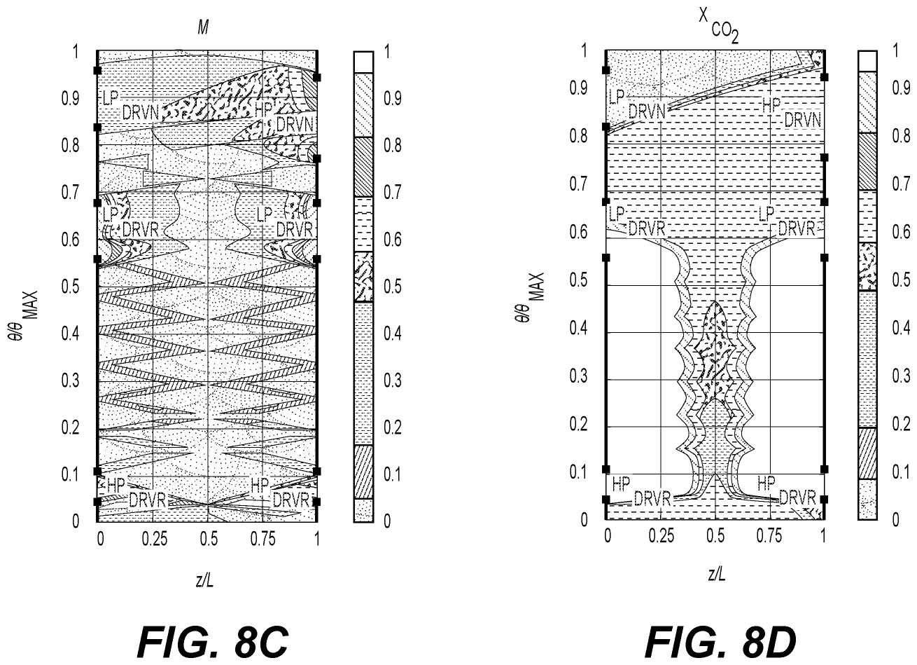

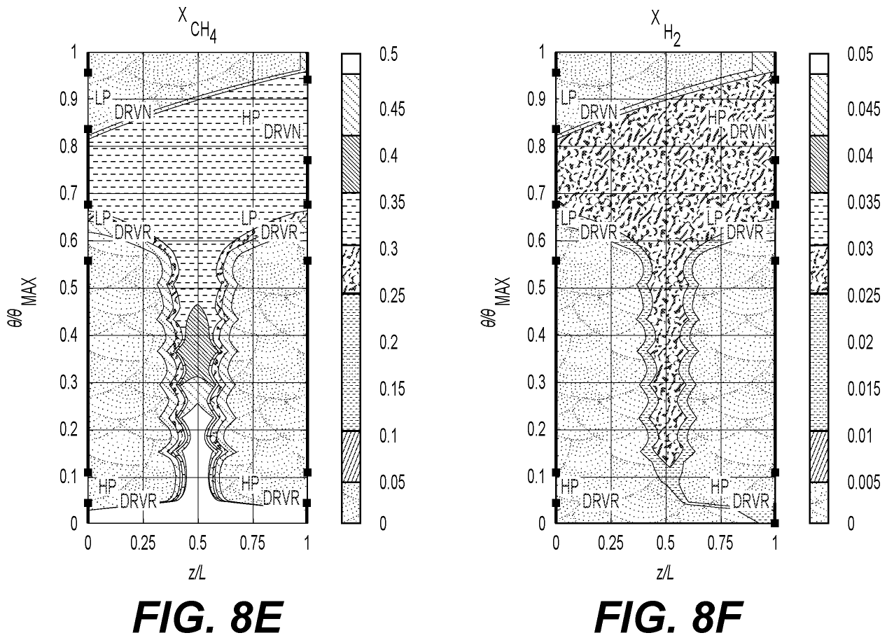

FIG. 8, including six charts 8a-8f represent a numerical modeling of an eight-port wave reformer with straight channels incorporating the wave cycle details discussed above. FIG. 8a (top) shows non-dimensional pressure (left), FIG. 8b relates to temperature (middle), and FIG. 8c shows Mach number (right) in a representative channel, as a function of time (vertical axis) and position (horizontal) over one complete cycle of operation. Hence, CO₂ and CH₄ are used as the driver and driven gases, respectively. Similarly, FIG. 8d (bottom) also shows corresponding molar fraction of CO₂ (left), FIG. 8e shows CH₄ (middle), and FIG. 8f shows H₂ (right).

### Converging Channels

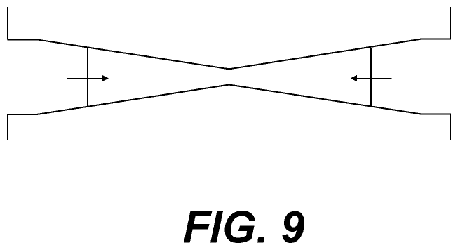

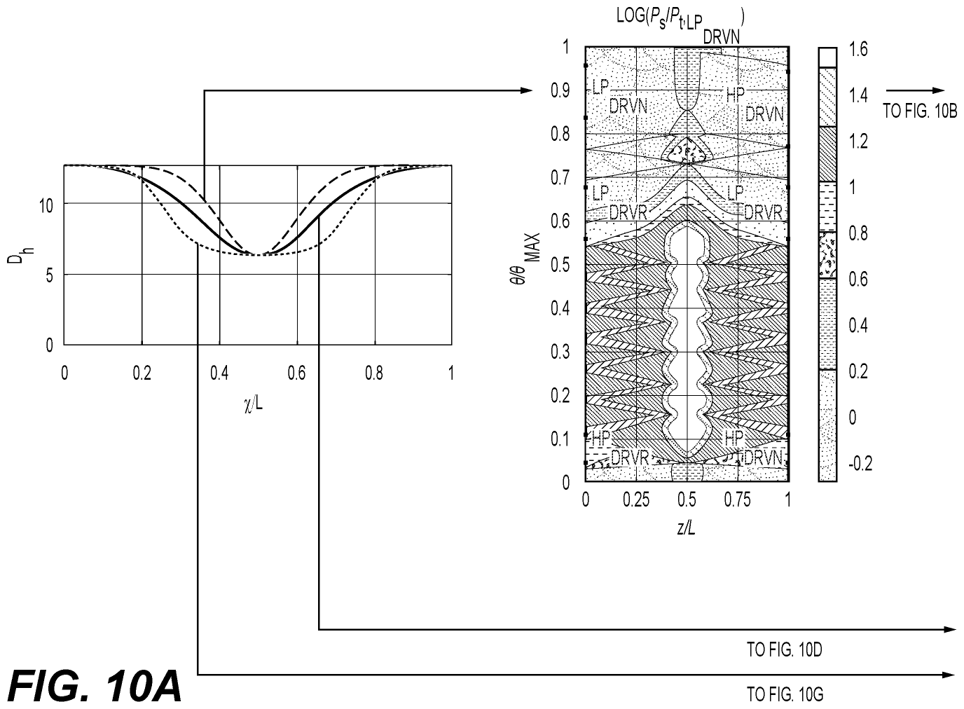

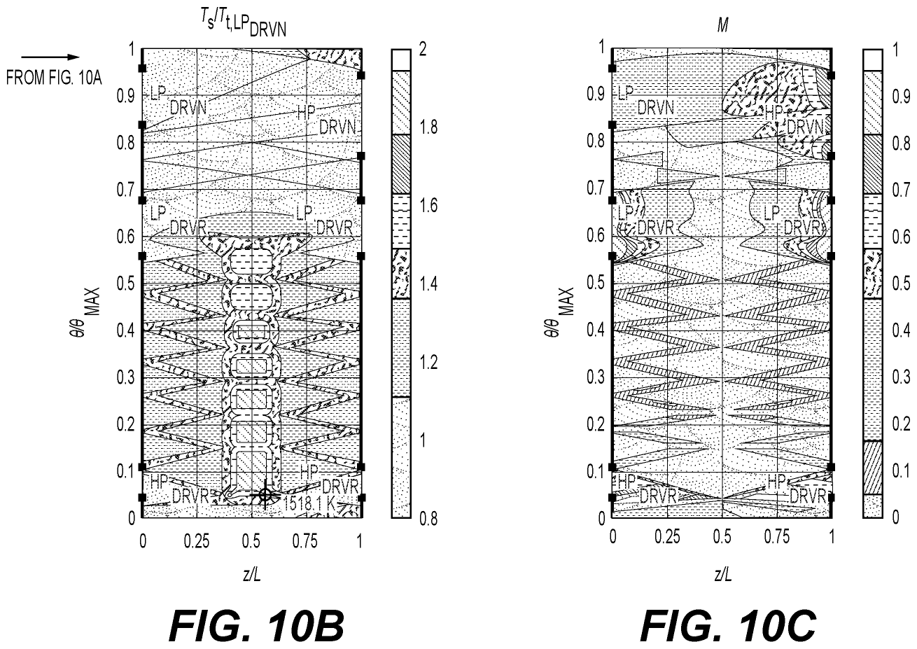

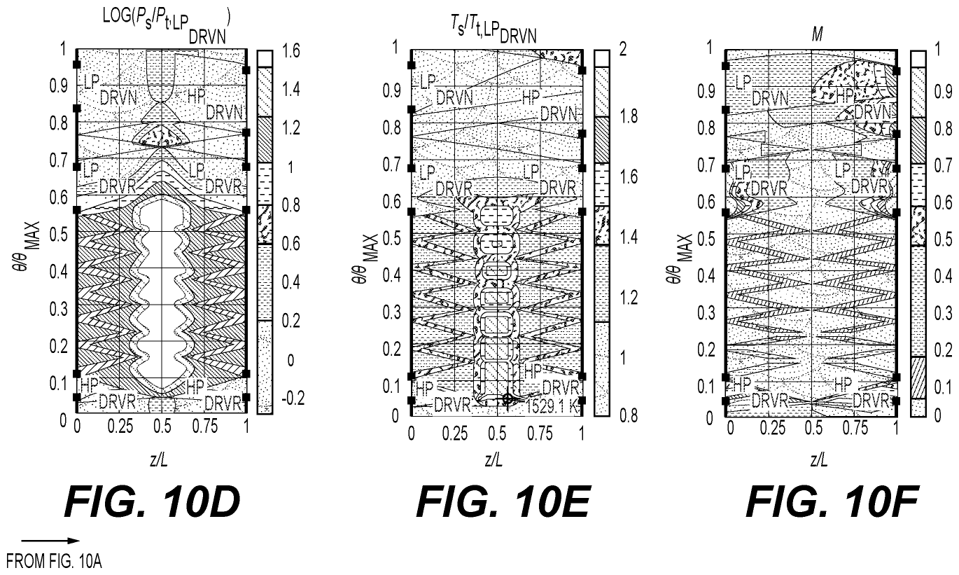

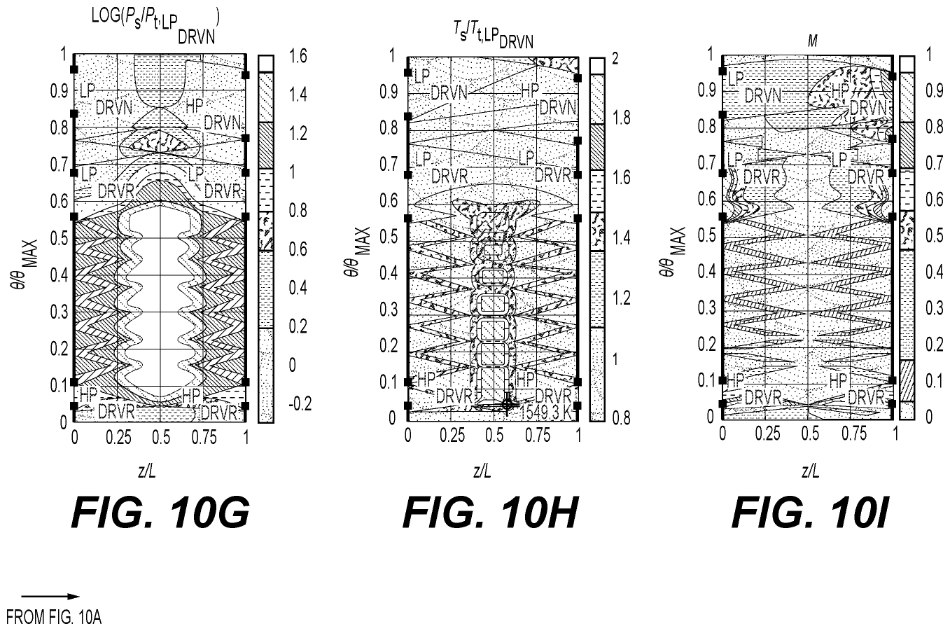

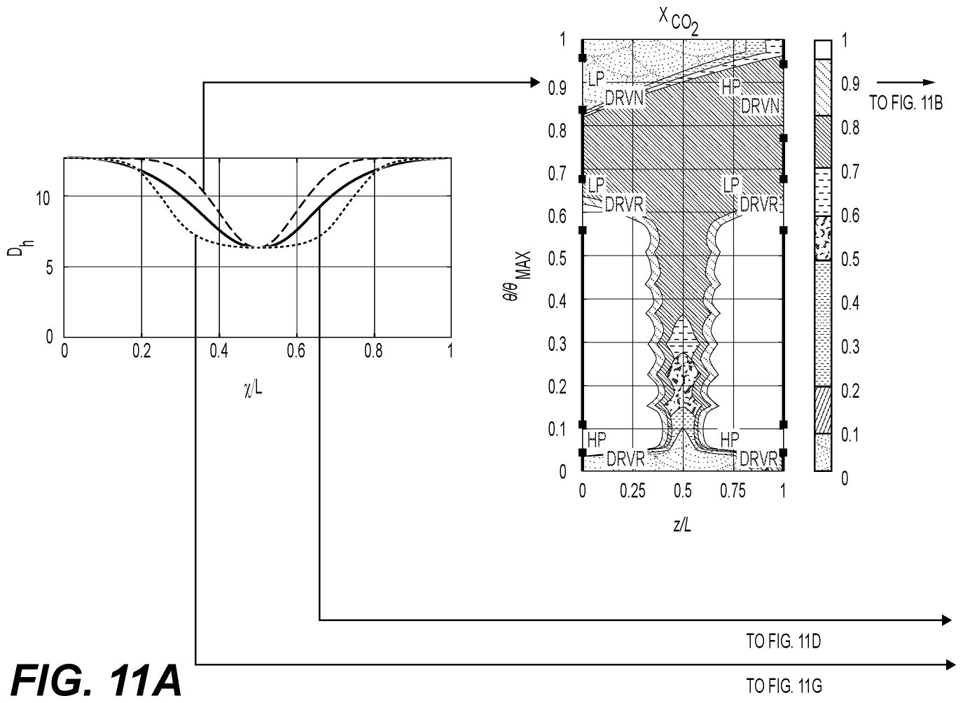

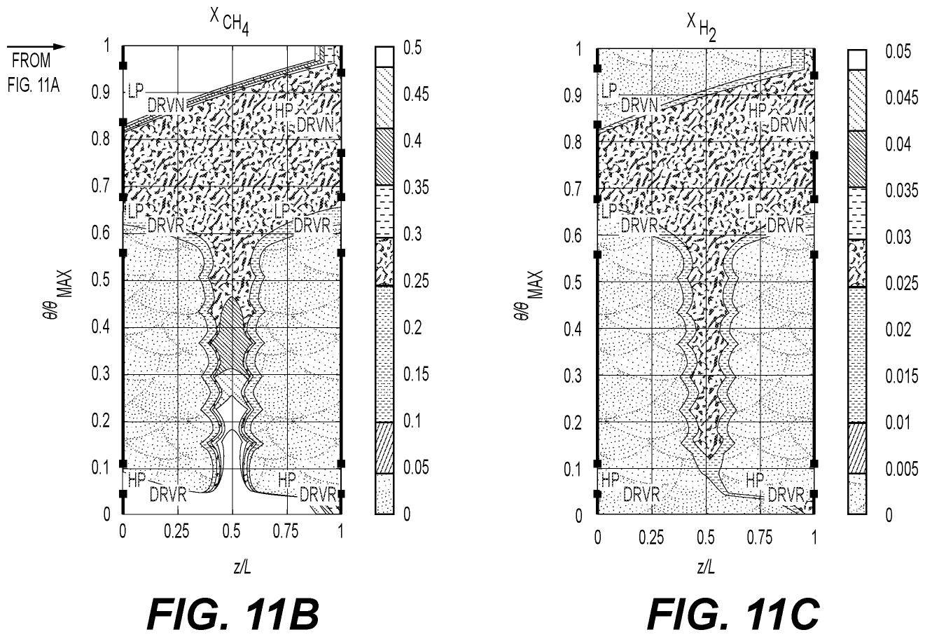

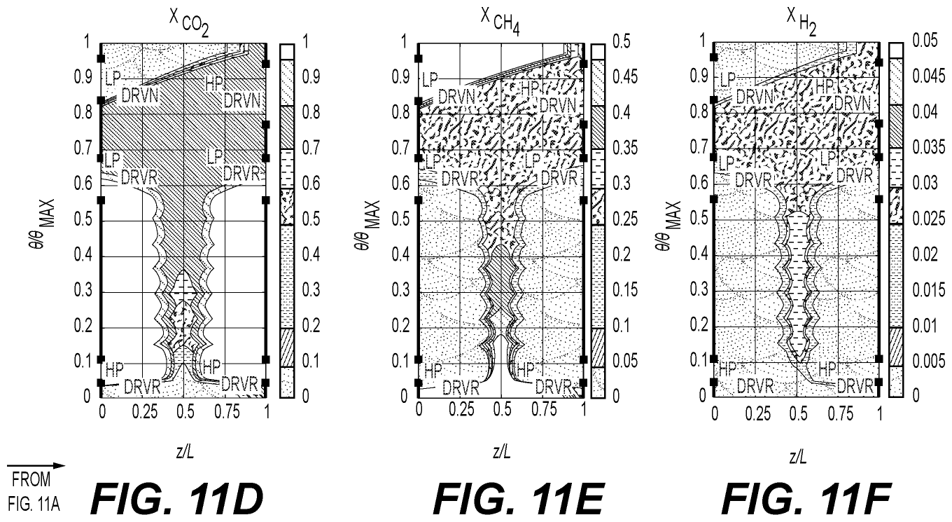

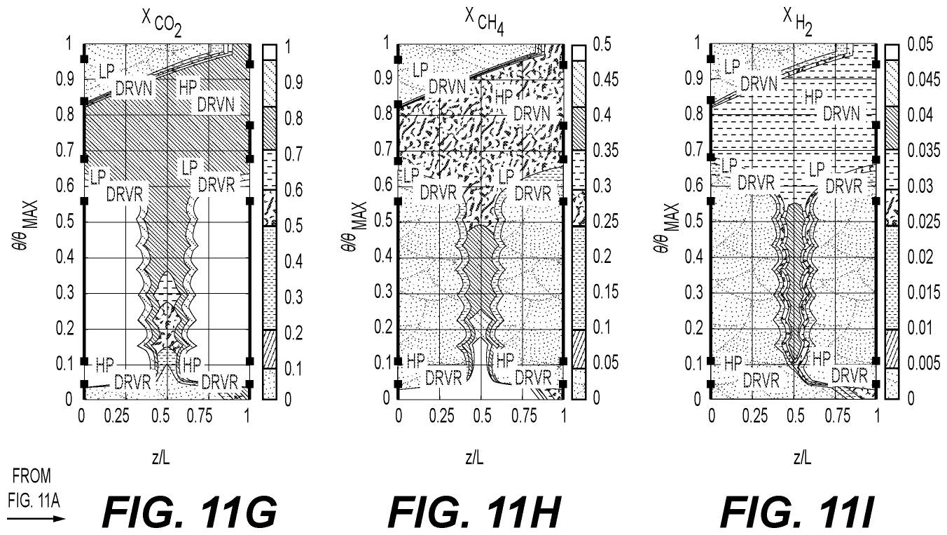

To accelerate the head-on colliding shock waves, it is proposed to allow channels in wave reformers to have an internal structure or shape that is gradually converging toward their centers forming a minimum area in the center, as schematically shown in FIG. 9. The channel shape shown in FIG. 9 is linear only to introduce the concept, but in practice it can be non-linear. Indeed, FIG. 9 is an example of how a straight channel can be modified to create a channel with a throat or a constricted area at the middle, that could be defined by a linearly decreasing cross-sectional area in the direction of travel of head-on colliding shock waves. The channel profiles shown in the left side of FIGS. 10 and 11 describe suggested channel shapes.

Similar to FIG. 8, FIGS. 10a-10i show numerical modeling of a six-port wave reformer employing three different wall shapers (red, blue and black) as indicated by the plot next to the flow properties contours. The side plot describes variation of the channel diameter along the channel length for three different channel wall distributions. Similarly, FIGS. 11a-11i show corresponding molar fraction of CO₂ (left), CH₄ (middle), and H₂ (right). of the same six-port wave reformer employing three different wall shapers (red, blue and black) as indicated by the plot next to the molar fractions. Compared with the straight channel (FIG. 8), channels with convergent shapes indicate higher peak temperatures and greater hydrogen productions.

### An Eight-Port Reverse-Flow Wave Reformer Using Channel Area Contraction

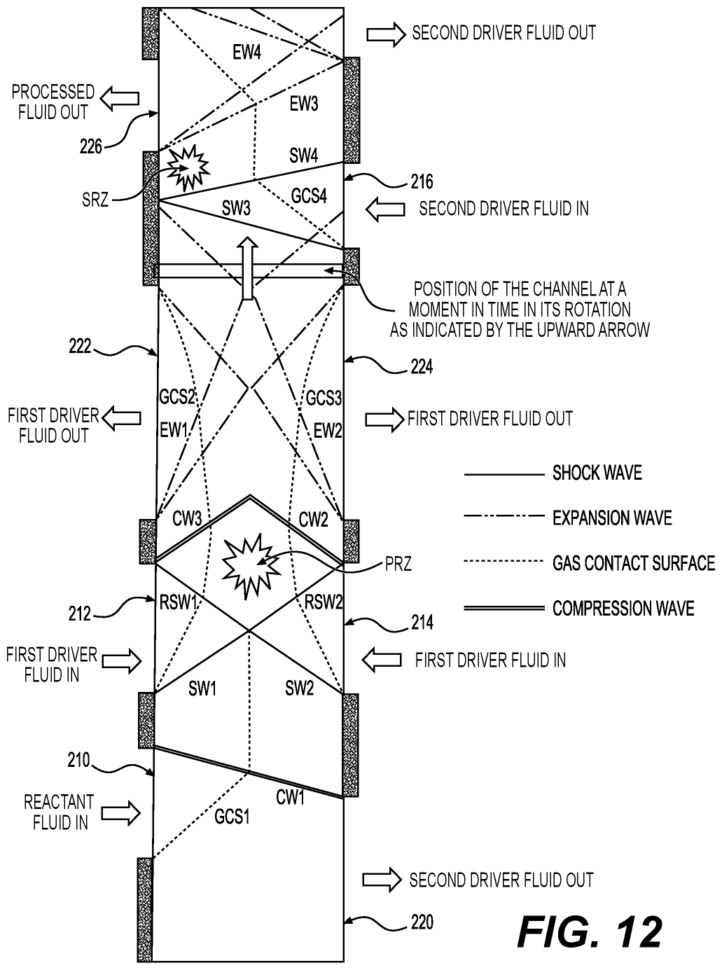

Another wave reformer that has potential for a greater fuel-to-hydrogen conversion is the eight-port wave reformer described here. The inner working fluid principles are shown in a wave diagram in FIG. 12. The present process begins at the bottom of the wave diagram where the low-pressure reactant fluid or gas entry port 22 opens at left side of diagram. The fresh reactant fluid 52 is charged into the upstream end of the channel (left side of diagram) while the processed fluid (e.g. product) is being discharged from the downstream end of the channel (right side of diagram) through an exhaust port 20. This is considered as the overlap process in which both channel ends at the bottom of the figure are open. A gas contact surface (GCS1) separates the fresh reacting gas 52 from the exhaust gas. When the entire channel is filled with the fresh reacting gas, the exit port 20 closes. By closing the outflow port 20, a compression wave CW (doubled solid line) is generated from the upper corner of the exit port 20 propagating to the left. The channel flow is brought to rest by this moving wave CW, which raises the pressure in the channel. When the compression wave CW meets the upper corner of the inlet port 22, the ingestion of the fresh gas into the channel is stopped. At this instance, the channel is fully filled with the pre-compressed fresh reacting gas. As the channel rotates further, the channel ends are exposed to high-pressure driver gas entry ports 24 and 26. Because the driver gas pressure is higher than the pressure in the channel, two identical primary shock waves SW1 and SW2, are triggered starting from the lower corners of the inlet ports 24 and 26. These primary shock waves SW1 and SW2 propagate toward each other and after colliding cause a sudden rise of pressure and temperature inside the channel in a reaction zone. Meanwhile, the driver gas entry ports 24 and 26 start to close. Because the velocity of the gas in contact with the closed end wall must be zero, expansion waves EW1 and EW2 are generated and propagated into the channel moving gas, bringing it to rest. Expansion waves EW1 and EW2 (dashed-dotted line) are generated from the upper corners of the entry ports 24 and 26 propagating toward the center of the channel reducing the pressure and temperature of the channel gas. Behind the primary shock waves SW1 and SW2, the compressed reacting gas and the driver gases 60 and 62 are separated through two contact surfaces GCS2 and GCS3 as the compression process is carried out. These contact surfaces (showing the progression of the two fluids) follow the shock waves SW1 and SW2 at a slower rate. The symmetric pairs of primary shock waves SW1 and SW2 collide in the middle of the channel and generate a pair of reflected shock waves RSW1 and RSW2. The pressure and temperature of the reacting gas in the reflection zone behind the reflected shock waves RSW1 and RSW2 rise further and the double-compressed gas 54 is brought to rest indicated by contact surfaces turning into vertical lines.

The top part of the cycle shown in FIG. 12 is similar to that in FIG. 2. A second driver gas enters via inlet port 216 into the channel when the right end of the channel is exposed to the secondary driver gas port 216. Thus, an additional set of incidence and reflected shock waves SW3 and SW4 creates a secondary reaction zone (SRZ) behind the reflected shock wave SW4. This secondary reaction zone contributes to more hydrogen generation in addition to that generated in the primary reaction zone (PRZ). The processed gas leaves the channel through the outlet port 226 placed at the left end wall 205. The port 226 remains open long enough to complete the scavenging of the processed gas facilitated by an expansion wave EW3 generated at the lower corner of the outlet port 226. The eight-port design still allows the reacting gas to enter and leave at the same end of the rotor via inlet port 210 and exhaust port 226. As the right end of the channel opens to another exhaust port 220, an expansion fan EW4 originates from the leading edge of the exhaust port 220 and propagates upstream into the channel, expanding and discharging the secondary driver gas to exhaust portion of the balance of systems, and the cycle repeats.

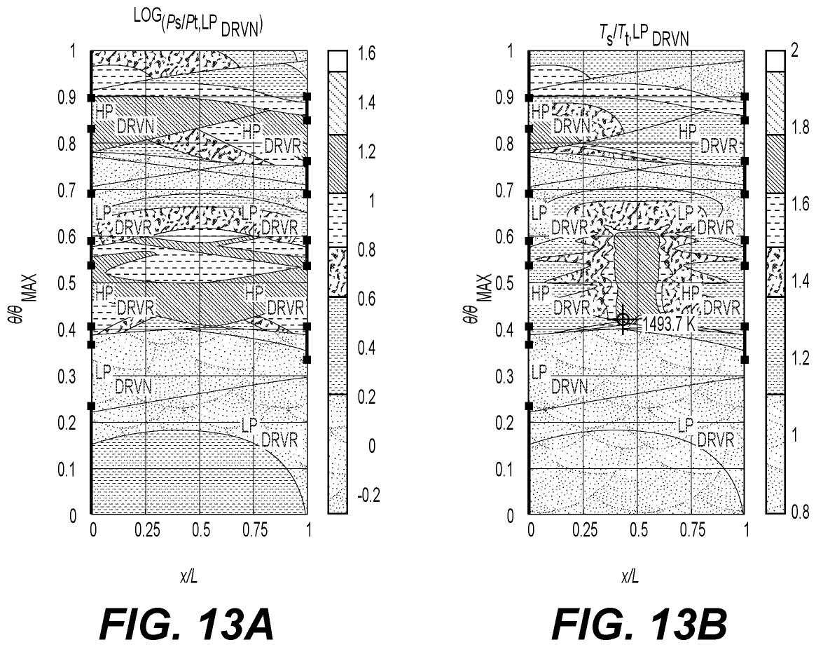

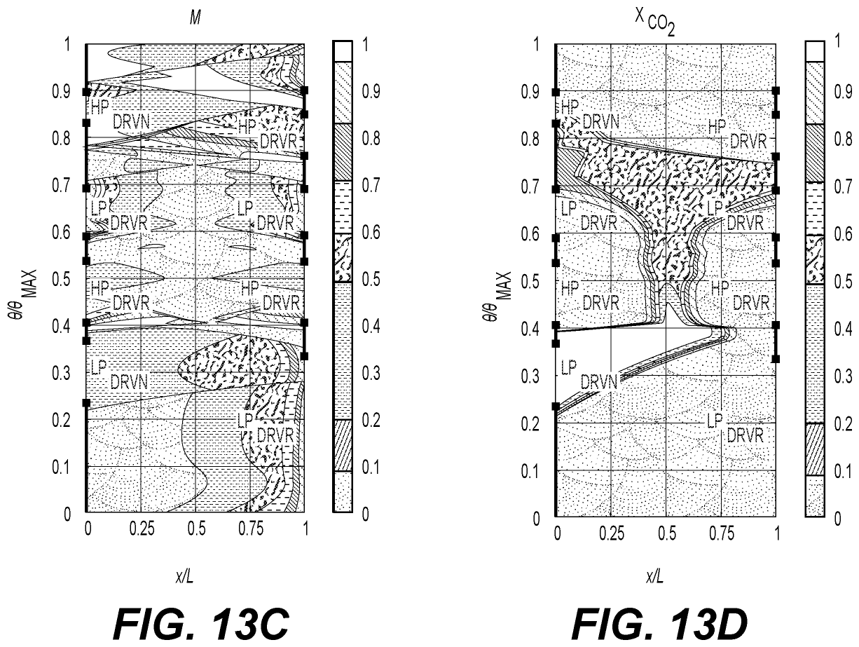

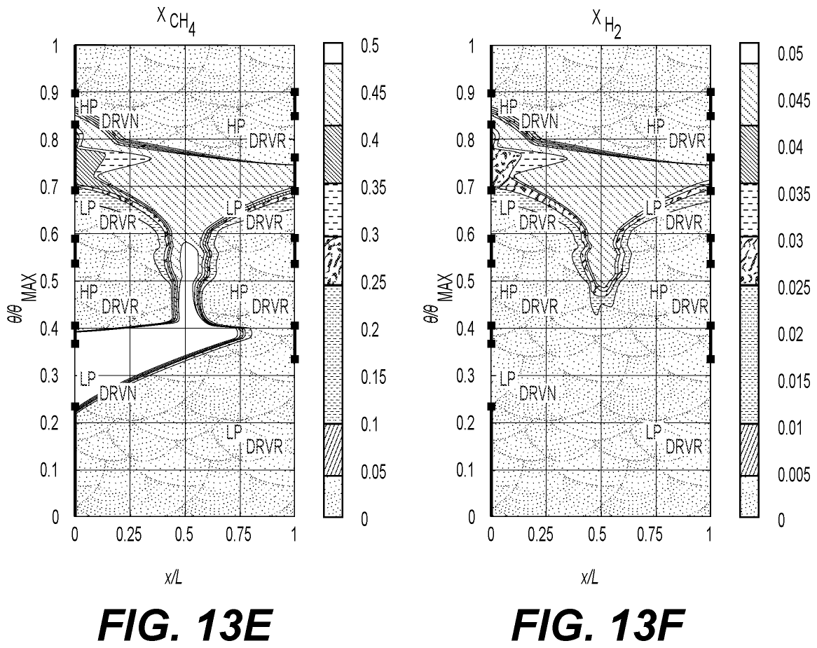

FIGS. 13a-13f represent a numerical modeling of an eight-port wave reformer with straight channels incorporating the wave cycle details discussed above. The top row of FIG. 13 shows non-dimensional pressure FIG. 13a (left), temperature FIG. 13b (middle), and Mach number FIG. 13c (right) in a representative channel, as a function of time (vertical axis) and position (horizontal) over one complete cycle of operation. Again, CO₂ and CH₄ are used as the driver and driven gases, respectively. Similarly, the bottom or of FIG. 13 also shows molar fraction of CO₂ FIG. 13d (left), CH₄ FIG. 13e (middle), and H₂ FIG. 13f (right).

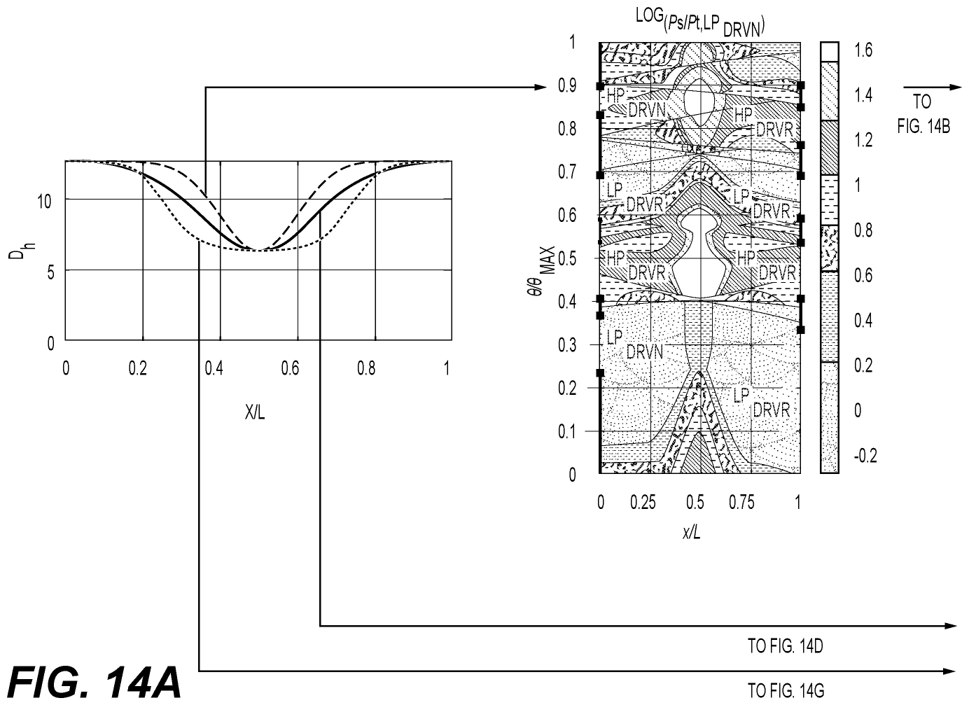

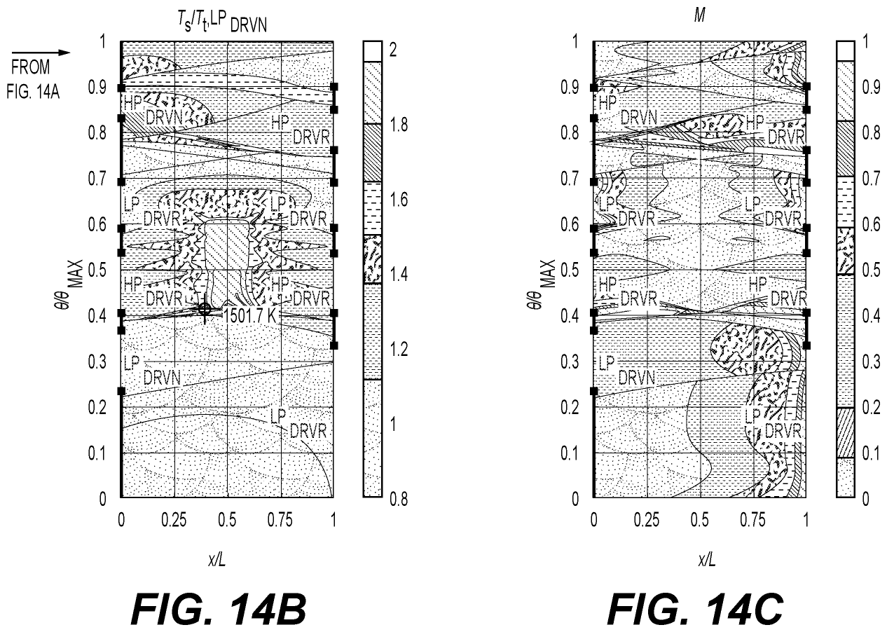

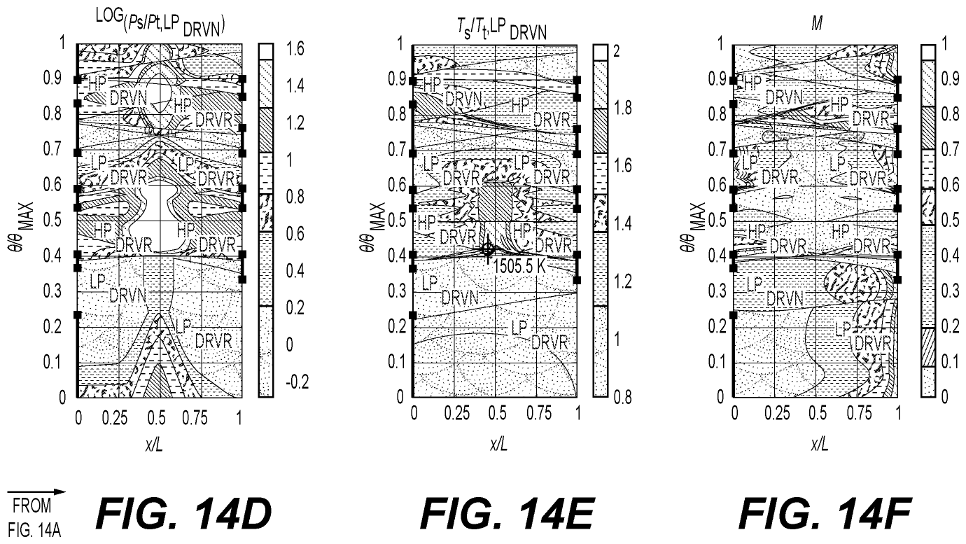

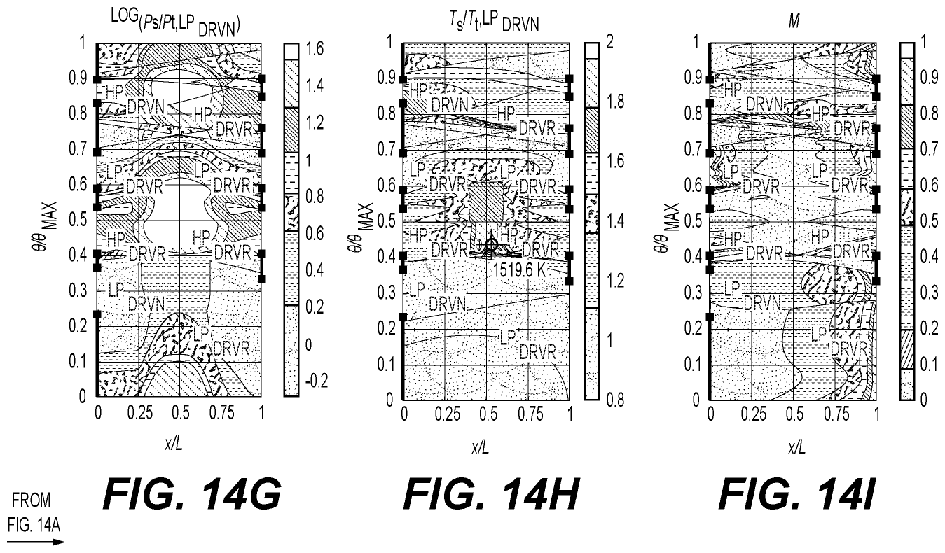

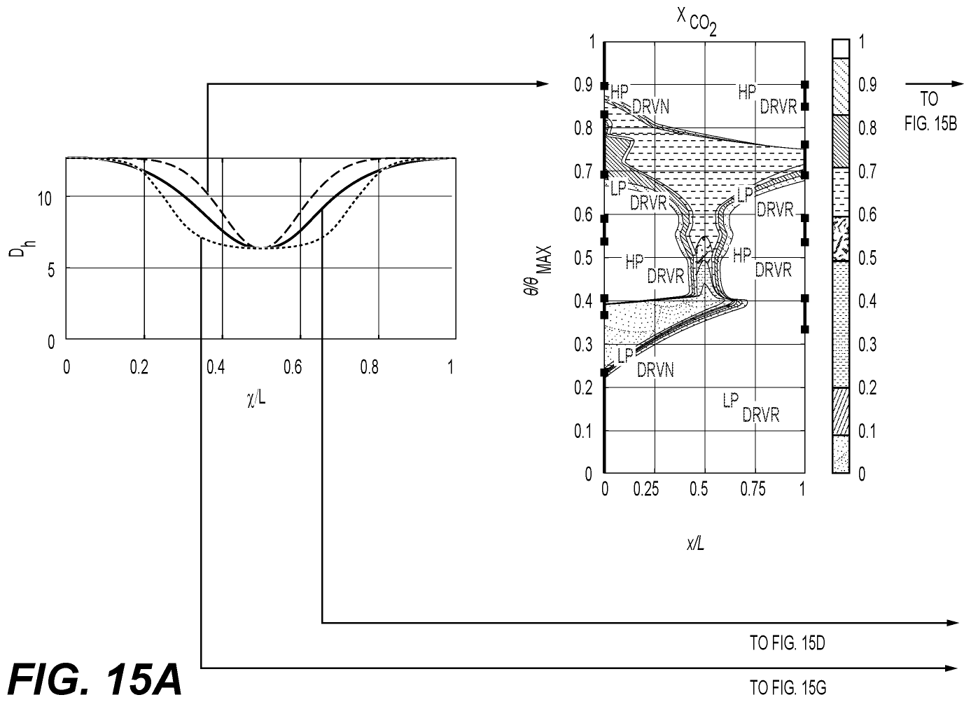

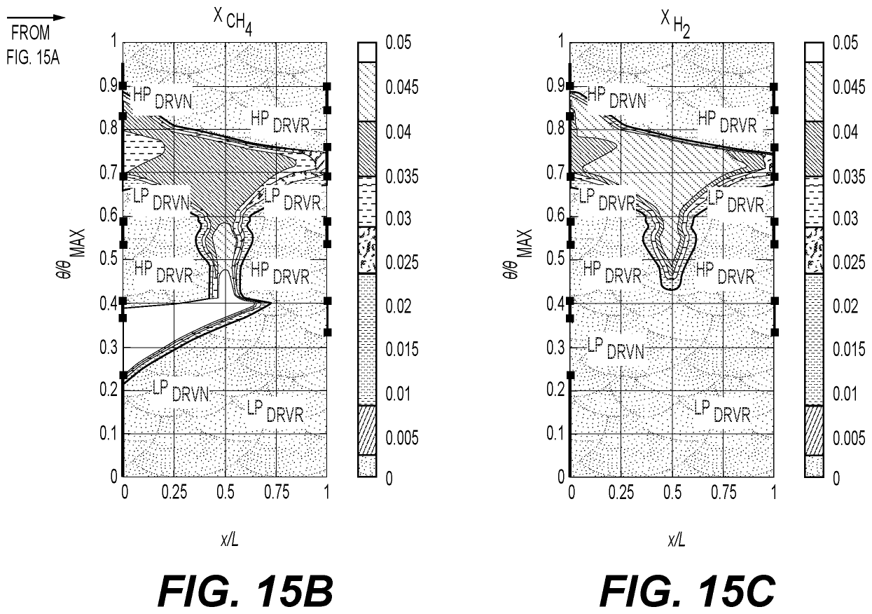

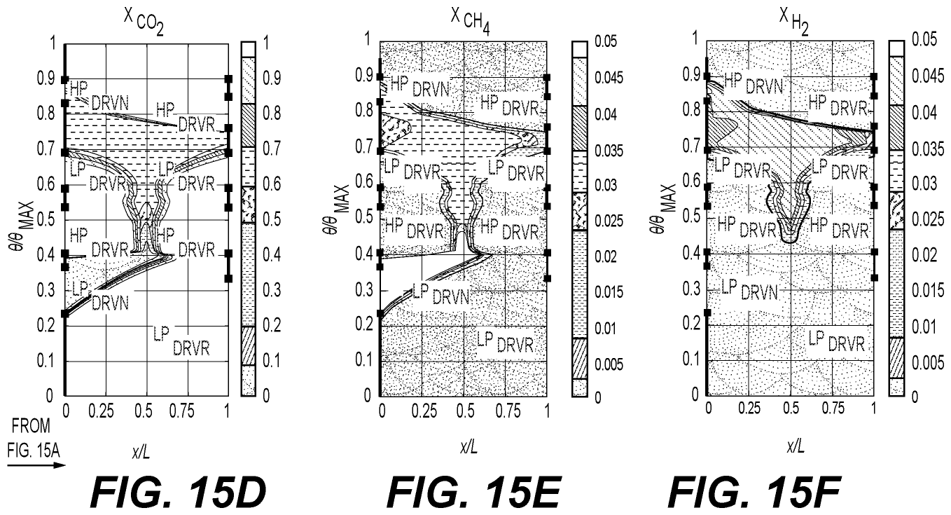

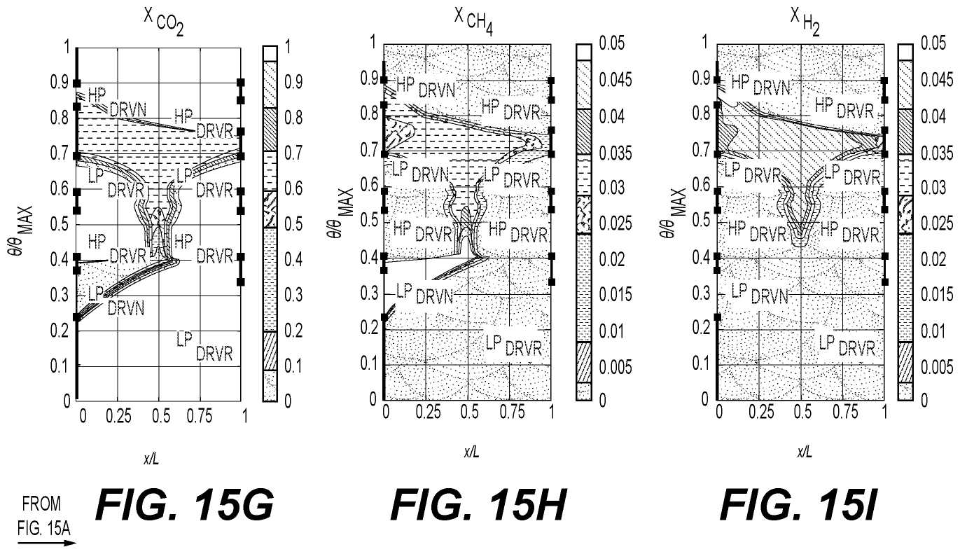

Similar to FIGS. 10 and 12, FIGS. 14 and 15 show numerical modeling of an eight-port wave reformer employing three different wall shapers as indicated by the plot next to the flow properties contours. FIGS. 14a-14i illustrate non-dimensional pressure (left), temperature (middle), and Mach number (right) and FIGS. 15a-15i show corresponding molar fraction of CO₂ (left), CH₄ (middle), and H₂ (right). Compared with the straight channel (FIG. 13), channels with convergent shapes indicate higher peak temperatures and greater hydrogen productions.

We claim:

1. A hydrogen generation system comprising a wave reformer in which shock and expansion waves are created in a manner causing head-on colliding shock waves and multi-stage compression where reacting gases within the wave reformer are heated and compressed to thermally crack or decompose one or more fuel sources, such as hydrocarbon fuels, to generate a fuel product containing hydrogen, wherein the internal configuration of channels within the wave reformer are defined by a shaped portion along a length thereof.

2. A hydrogen generation system comprising a wave reformer in which shock and expansion waves are created in a manner causing head-on colliding shock waves and multi-stage compression where reacting gases within the wave reformer are heated and compressed to thermally crack or decompose one or more fuel sources, such as hydrocarbon fuels, to generate a fuel product containing hydrogen, wherein the internal configuration of the wave reformer includes a shaped portion at a point along a length thereof.

3. The hydrogen generation system of claim 1 wherein the shaped portion comprises a linearly reduced section.

4. A hydrogen generation system comprising a multi-port wave reactor, including a rotor rotating within an outer casing and supporting end walls at opposite ends thereof, and a plurality of spaced apart channels within the rotor in which shock and expansion waves are created in a manner causing multi-stage shock compression where reacting gases remain for a longer time within the multi-port wave reactor and are heated and compressed to thermally crack or decompose one or more fuel sources to generate a fuel product containing hydrogen, the system further including an internal constriction formed at a point along the length of at least one of said plurality of channels so that gases are forced through the constricted portion.

5. A multi-port wave reformer having a plurality of inlet ports and exhaust ports provided in end walls thereof, with an inlet port spaced from an exhaust port on one side of the wave reformer that collectively allows a driven reactant gas to enter and leave from one side of the wave reformer, and an additional plurality of inlet ports and exhaust ports on an opposite side of the wave reformer, including two spaced apart inlet ports alternating with two spaced apart exhaust ports through which driver gases are fed into and expelled out of the wave rotor, said multi-port wave reformer further including a throated area located along a length thereof through which gasses are forced to pass.

6. A method of generating hydrogen from a hydrocarbon using a multi-port wave reactor employing multiple expansion reaction zones including the steps of:
inputting a low-pressure reactant fluid into the wave reactor through a first port at one end of a wave reactor rotor and discharging the low-pressure reactant fluid as a high-pressure processed fluid from the same one end through a second port;
inputting a first driver fluid at the same one end through a third port and creating a first reaction zone within the rotor channel, and
discharging the first driver fluid from the same one end thereof through a fourth port;
inputting another portion of the first driver fluid at an opposite end of the rotor through a fifth port and discharging the another portion of the first driver fluid from the same opposite end through a sixth port;
inputting a second driver fluid at the same opposite end of the rotor through a seventh port and creating a second reaction zone, and
discharging the second driver fluid from the same opposite end through an eight port.
